(19) United States
(12) Patent Application Publication
(10) Pub. No.: US 2011/0273552 A1
(43) Pub. Date: Nov. 10, 2011

(54) METHOD AND APPARATUS FOR ACCESSING EXERCISE WHILE WATCHING TV

(75) Inventors: Jin Wang, Shanghai (CN); Yunqiang Liu, Shanghai (CN); Huanhuan Zhang, Shanghai (CN)

(73) Assignee: KONINKLIJKE PHILIPS ELECTRONICS N.V., EINDHOVEN (NL)

(21) Appl. No.: 13/144,417

(22) PCT Filed: Jan. 18, 2010
(86) PCT No.: PCT/IB2010/050221

§ 371 Date: Jul. 13, 2011

(30) Foreign Application Priority Data
Jan. 21, 2009 (EP) 09150989.3

(51) Int. Cl. H04N 5/445; H04N 7/18

(52) U.S. Cl. 348/77; 348/564; 348/734; 348/E05.104; 348/E07.085

(57) ABSTRACT

The present invention provides a complete solution for accessing an exercise or training program quickly and easily (e.g. with just one or a few button pushes on a remote control) at anytime while watching TV.

### FIELD OF THE INVENTION

The present invention relates to a method, apparatus, system and software for quick and easy accession to exercise or training programs while watching TV.

### BACKGROUND OF THE INVENTION

Fast lifestyle and high work pressure leads to lots of diseases because of the lack of exercise. With a more sedentary lifestyle and unhealthy eating habits, the human population is getting out of shape fast. During their daily life routine, people are not physically active enough to maintain a healthy body weight. These trends lead to a called lifestyle epidemic, where worldwide over one billion people are overweight.

The importance of a healthy lifestyle is becoming more evident for consumers than ever before. The consumers are more and more striving for a healthy lifestyle, for example by looking after their nutritional habits or improving their physical activity by working-out in a fitness centre and/or jogging in the park. We can see that the food industry is offering more and more diet products and detailed product information to enable the consumer to nurture or feed in a healthy manner. Also more and more fitness centers around the globe are being opened, which enables and allows even more enthusiasts to join in, participate and be a part of it.

Moreover, people are busy working in a pressured society. In order to release the working pressure, they go travelling, go to gyms, watch TV at home, etc. Since people have to stay at home most of the time, they spend lots of time watching TV in order to relax. However, people want to keep a healthy body while they are relaxing at home.

Hence, a way of quick and easy accession to exercise or training programs while watching TV is needed and would be appreciated.

### OBJECTS OF THE INVENTION

People generally watch TV for a long time in order to relax. In addition they are always gaining weight due to the lack of enough exercise, which leads to lots of diseases such as obesity, hypertension and so on. Doing nothing when watching TV commercials or uninteresting programs makes people feel uncomfortable. Some persons want to exercise during this time, but there is no simple and quick way to access exercise or training programs as they want. Moreover, people have different dislikes and preferences with regard to the exercise or training programs.

It may be seen as an object of the present invention to provide a method, apparatus, system and software for quick and easy access or accession to exercise or training programs while watching TV, that solves the above mentioned problems.

It is a further object of the present invention to provide an alternative to the prior art.

### SUMMARY OF THE INVENTION

The present invention overcomes the above-identified deficiencies and solves at least the above identified problems by providing a method, an apparatus, a system and a computer program product on a computer readable medium according to the appended patent claims. The main features of the present invention are described in the independent claims. Additional features of the invention are presented in the dependent claims.

One aspect of the invention provides a complete solution, in form of a method, an apparatus and/or a system, to access an exercise or training program quickly and easily (e.g. with just one or a few button pushes on a remote control) at any time while watching TV or video on a TV or a PC.

Another aspect of the invention provides a remote control comprising a button thereon, which can be called “exeTV”, for quick and/or easy access (in just a couple of steps) to exercise or training program(s) at any time while watching TV or video. As soon as or when a user presses or pushes this button just once, an exercise interface can be reached, opened and/or presented (to the user). By using for example the conventional buttons of the remote control, the user can then select a favorite short-time exercise program from a list of such programs which can be pre-stored into a small memory or storing device, such as for example a small flash memory, USB stick or the like, which can be integrated with or insertable within the TV or the PC. The information on said small memory or storing device, and more particularly the exercises stored thereon, can be downloaded and/or updated wired (e.g. USB, suitable cables, etc.) or wireless (e.g. Bluetooth, WLAN, etc.) with the help of a computer, a mobile phone, a cable or satellite TV provider or such a service on the internet. Various exercises can be stored in a database accessible via the mobile phone, the internet or the cable or satellite TV provider.

A further aspect of the invention provides interaction with the user or exerciser and/or providing feedback regarding the posture of the user or exerciser.

These functions can also be implemented in the applications of IPTV (Internet Protocol Television) or interactive TV to provide advanced features.

Another aspect of the present invention is to provide software.

Accordingly, the invention preferably seeks to mitigate, alleviate or eliminate one or more of the above mentioned deficiencies singly or in any combination.

In general by writing that “it is an advantage” by the present invention and referring to an advantage, it must be understood that this advantage may be seen as a possible advantage provided by the invention, but it may also be understood that the invention is particularly, but not exclusively, advantageous for obtaining the described advantage.

In general the various objects, aspects, features and/or advantages of the invention may be combined and coupled in any way possible within the scope of the invention.

The individual objects, aspects, features and/or advantages of the present invention may each be combined with any of the other one(s). These and other objects, aspects, features and/or advantages of the invention will be apparent from the following description and elucidated with reference to the embodiments described hereinafter.

### BRIEF DESCRIPTION OF THE DRAWINGS

The present invention will now be explained, by way of example only, with reference to the accompanying drawings, where:

FIG. 1 shows a remote control according to the present invention comprising a button “exeTV” thereon; and

FIG. 2 illustrates one embodiment of the invention, wherein feedback can be provided to the user or exerciser;

The drawings show one way of implementing the present invention and are not to be construed as being limiting to other possible embodiments falling within the scope of the attached claim set.

### DETAILED DESCRIPTION OF THE INVENTION

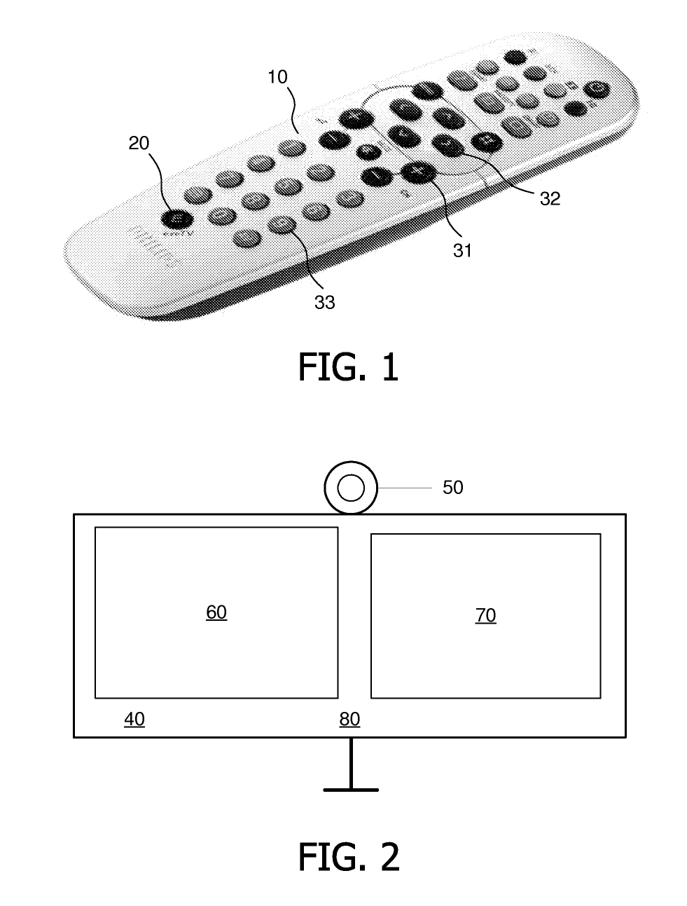

FIG. 1 illustrates an apparatus according to the present invention in the form of a remote control 10 comprising a special button 20, called “exeTV”, thereon, which button 20 allows quick and easy access (in just a couple of steps or button pushes) to exercise or training program(s) while watching TV.

When the user presses this button 20, the exercise interface can be presented (on at least part of a screen). He/she can thereafter select or choose (e.g. by using the scrolling 31 (+, −), 32 (<, >, ̂, v), the number 33 or other buttons on the remote control 10) his/her favorite short-time exercise program which can be pre-stored into a small flash memory or the like integrated with or insertable within a TV. The selection can be confirmed by for example pressing or pushing the “OK” or “exeTV” 20 button. Then the exercise program will be played on at least one part of the screen. Short cuts can be provided: e.g. by pushing the special or “exeTV” button 20 twice, the last used or the most used exercise program can be played/displayed. The time length of the exercise program can be about 3 to 5 minutes or more. These programs can be downloaded or updated by using a wired (e.g. USB, cables, etc.) or wireless (e.g. Bluetooth, WLAN, etc.) connection(s) and with the help of a mobile phone, a computer, a cable or satellite TV provider or a service on the internet, manually or automatically according to the exerciser's or user's preference(s). The programs, mentioned above, can be video(s) for exercise coach, such as a yoga coach, an aerobics coach, etc. The user or exerciser can follow the exercise in the video, and furthermore an additional device can be used to detect and analyze the user's or exerciser's motion and give him/her some advices. When using the cable or satellite TV provider mentioned above, these exercise programs can also for example be available by scanning all existing TV channels. Certain exercise program(s) can be stored or kept on a storage device, such as for example a hard disk, a recordable DVD, etc., according to the exerciser's or user's preference(s). The system can be used to search exercise programs from other channels (e.g. different from the one being watched) with the help of at least one preference key word, such as for example “yoga” or “aerobics”. Said at least one preference key word can also be used by the system to search the Electronic Program Guides (EPGs) of all existing TV channels in order to find programs fulfilling the search criteria, i.e. preferred exercise programs. All these exercise programs can be recorded onto the storage device.

There are two ways to interact with the exercise coach:

A simple way is that the exerciser can only follow the coach on (at least a part of) the screen and no feedback is provided.

Another way is the interactive type (shown on FIG. 2). The system will give some feedback during and/or after the exercise. The simple way is that another video of the exerciser is captured by a video camera 50 and is displayed on at least one part 70 of the screen of a TV 40 or a PC (which captured video can look like a virtual mirror) when and/or after the display of the exercise program on at least one part 60 of the screen. The played or the remaining time 80 can be displayed (respectively, in an increasing or decreasing manner) on the screen, alone or together with the actual time.

For the interactive type, preprogrammed software can be pre-stored on a hard disk or other storage device, such as for example flash memory, DVD, etc. The software can have one or several functions: i) detect the motion of the user's body, ii) analyze the motion or posture, iii) evaluate the motion or posture, and iv) give advice or encouragement according the evaluation and/or analysis. The software can be invoked at a suitable time. After the exerciser has taken exercise for a certain period of time, which means that he/she has insisted on exercising for some time, then the software can give the exerciser some reward(s) and/or encouragement(s), wherein the reward(s) and/or encouragement(s) can be virtual. The time or the period of time (after which a reward and/or encouragement is given) can be predefined or predetermined or preprogrammed adaptively according to the type of each exercise program.

One or several sensors, such as inertial sensor(s), can be also added into the remote control 10 or used as a separate accessory (e.g. a belt-like, a button-like or a stick-like object) attachable to a part of the body of the user or exerciser in order to guide the user's or exerciser's posture.

All related motion parameters, for example the orientation of the coach, can be pre-stored together with the coach video as a script. If the exerciser or user would like to look at the posture of a certain part of his/her body, for example the upper arm, the exerciser can simply wear a belt containing at least one inertial sensor on the specified part. Then the system can evaluate the posture of the exerciser by calculating the difference between the orientation of the coach and that of the exerciser.

Here is one example of evaluation method using Euler angle:

$$PoseRating = \frac{{\sum }_{i = 0}^{NumFrames} {\sum }_{j = 0}^{NumBones} ( \begin{matrix}\vert C {θ}_{i , j} - E {θ}_{i , j} \vert + \vert C {φ}_{i , j} - E {φ}_{i , j} \vert + \\ \vert C {ψ}_{i , j} - E {ψ}_{i , j} \vert\end{matrix} )}{NumBones \times NumFrames}$$

where: C represents the coach, E represents the exerciser, θ represents yaw, φ represents pitch, and ψ represents roll.

The quaternion measure can also be used for evaluation, and the criterion will then be:

$$PoseRating = \frac{{\sum }_{i = 0}^{NumFrames} {\sum }_{j = 0}^{NumBones} {α}_{j} \vert {q}_{Ci , j} - {q}_{Ei , j} \vert}{NumBones \times NumFrames}$$

where: and q_{Ci,j} and q_{Ei,j} denote the quaternion of the j bones of the coach and the exerciser in frame i, respectively; and αⱼ is the weighted coefficient of bone j, which means that different bones take a different importance in evaluating an articulate motion.

Based on the above equation, the user can get a simple evaluation of his/her position. In fact, if the user's or exerciser's position is not good, the device can remind him/her by using audio or/and visual signal(s).

One embodiment of the invention describes a method for accessing an exercise or training program by a user at any time while watching TV or video, comprising the following steps:

activating or selecting, by the user, an exercise mode, e.g. by pressing or pushing an exercise button added on a remote control;

showing an exercise interface on at least part of a screen or display;

choosing, by the user and with the help of the scrolling or other buttons on the remote control, a certain short-time exercise program from a list of exercise programs shown on the exercise interface and pre-stored on a small memory or storing device;

confirming the choice by pressing or pushing, by the user, the confirm/OK or other button (e.g. the added exercise button) on the remote control; and

starting the short-time exercise program and playing it on at least part of the screen/display.

In addition the method can be interactive with the user or exerciser. Each of the two ways, described above, can be used to interact with the exercise coach, wherein the simple way is that the exerciser can only follow the coach on the screen and the real-time image of the exercise is displayed or played on the screen and no other feedback is provided. The other way is that the system will give some feedback during and/or after the exercise.

The user's exercising can be captured by a video camera in order to be displayed, on at least a part of the screen, simultaneously with the exercise program playback. The captured video of the user exercising can also be stored in order to be displayed, on at least part of the screen, after the exercise program is completed, e.g. for analyzing the user's or exerciser's performance and/or posture.

Furthermore, the position or posture of at least one part of the body of the user or exerciser can be evaluated continuously. This can for example be done by using an algorithm (for example, but not limited to, the algorithms described above) for calculating the difference between the orientation of the coach of the exercise program and that of the user. During the training or exercising audio or/and visual signal(s) can be given to the user when the difference between the user's and the coach's posture and/or orientation is bigger than a predetermined one.

The exercise programs can be updated from a database comprising various exercise programs according to the user's preferences. The preferred exercise programs can be downloadable onto a small memory or storing device.

One embodiment of the invention describes a system for accessing an exercise or training program by a user at any time while watching TV or video, comprising:
a remote control comprising an exercise button allowing the user to activate or select an exercise mode, e.g. by pressing or pushing this button;

a screen for showing or presenting an exercise interface on at least part of said screen;

a small memory or storing device for pre-storing exercise programs, wherein a list of these exercise programs can be shown within the exercise interface in order to allow the user to choose a certain short-time exercise program, and wherein the remote control further comprises any kind of navigating or scrolling buttons allowing the user to review and navigate within the list of said exercise programs and at least one button, e.g. a confirmation or OK button, allowing the user to confirm his/her choice(s) and choose said certain short-time exercise program;

control means for starting the short-time exercise program and playing it on at least part of the screen.

System can further comprise feedback means for providing feedback to the user during and/or after the playback of the exercise program.

In addition, the system can comprise a video camera for capturing the user's exercising, as well as display means for displaying the captured video of the user exercising on at least part of the screen simultaneously with the exercise program playback and/or after the exercise program is completed.

The system can also comprise means for continuous evaluation of the position of at least one part of the body of the user or exerciser.

Furthermore, the system can comprise means for giving an audio or/and visual signal to the user when a difference between the user's and the coach's posture and/or orientation is bigger than a predetermined one.

The system can comprise means for updating the exercise programs according to the user's preferences.

The system can use at least one inertial sensor to measure the motion of the exerciser or user and evaluate the posture of the exerciser/user.

The inertial sensor can be embedded in the remote control and/or can be integrated within a separate accessory (e.g. a belt-like, a button-like or a stick-like object) and can be attachable to a part of the body of the user or exerciser in order to guide the user's or exerciser's posture and/or orientation.

The inertial sensor can also help to control the TV since it can provide the motion information. The motion information can be interpreted as some control command such as program UP/DOWN, etc.

One embodiment of the invention describes a remote control for allowing access to an exercise or training program by a user at any time while watching TV or video, comprising:

an exercise button allowing the user to activate or select an exercise mode, e.g. by pressing or pushing this button, so that an exercise interface is shown or presented on at least part of a screen;

navigating or scrolling buttons allowing the user to review and navigate within a list of exercise programs pre-stored on a small memory or storing device, so that the user is able to choose a certain short-time exercise program from those on the list shown within the exercise interface; and

at least one button, e.g. a confirmation or OK button, allowing the user to confirm his/her choice(s) and to choose said certain short-time exercise program for playing or displaying it on at least part of the screen.

The invention can be implemented in any suitable form including hardware, software, firmware or any combination of these. The invention or some features of the invention can be implemented as computer software running on one or more data processors and/or digital signal processors. The individual elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

One embodiment of the invention concerns computer readable and/or useable code on a computer readable and/or useable medium adapted to perform the method of the present invention.

One embodiment of the invention concerns computer readable and/or useable code on a computer readable and/or useable medium adapted to be run on and manage the operations or functions of the system according to the present invention.

One embodiment of the invention concerns computer readable and/or useable code on a computer readable and/or useable medium adapted to be run on and manage the operations and/or functions of the remote control according to the present invention.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. Method for accessing an exercise or training program by a user at any time while watching TV or video, comprising the following steps:
activating or selecting, by the user, an exercise mode, e.g. by pressing or pushing an exercise button on a remote control;
showing an exercise interface on at least part of a screen;
choosing, by the user and with the help of the scrolling or other buttons on the remote control, a certain short-time exercise program from a list of exercise programs shown on the exercise interface and pre-stored on a small memory or storing device;
confirming the choice by pressing or pushing, by the user, the confirm/OK or other button on the remote control; and
starting the short-time exercise program and playing it on at least part of the screen.

2. Method according to claim 1, further comprising the step of:
providing feedback to the user during the playback of the exercise program.

3. Method according to claim 2, wherein the feedback providing step comprises:
capturing the user's exercising by a video camera; and
displaying, on at least part of the screen and simultaneously with the exercise program playback, the captured video of the user exercising.

4. Method according to claim 1 further comprising the step of:
providing feedback to the user after the playback of the exercise program.

5. Method according to claim 4, wherein the feedback providing step comprises:
capturing the user's exercising by a video camera;
storing the captured video; and
displaying, on at least part of the screen, the captured video of the user exercising after the exercise program is completed.

6. Method according to claim 1, further comprising the step of:
continuous evaluating the position of at least one part of the body of the user.

7. Method according to claim 6, further comprising the step of:
giving an audio or/and visual signal to the user when a difference between the user's and the coach's postures is bigger than a predetermined one.

8. System for accessing an exercise or training program by a user at any time while watching TV or video, comprising:
a remote control comprising an exercise button allowing the user to activate or select an exercise mode, e.g. by pressing or pushing this button;
a screen for showing or presenting an exercise interface on at least part of said screen;
a small memory or storing device for pre-storing exercise programs, wherein a list of these exercise programs can be shown within the exercise interface in order to allow the user to choose a certain short-time exercise program, and wherein the remote control further comprises any kind of navigating or scrolling buttons allowing the user to review and navigate within the list of said exercise programs and at least one button, e.g. a confirmation or OK button, allowing the user to confirm his/her choice(s) and choose said certain short-time exercise program;
control means for starting the short-time exercise program and playing it on at least part of the screen.

9. System according to claim 8, further comprising feedback means for providing feedback to the user during and/or after the playback of the exercise program.

10. System according to claim 9, further comprising a video camera for capturing the user's exercising, and display means for displaying the captured video of the user exercising on at least part of the screen simultaneously with the exercise program playback and/or after the exercise program is completed.

11. System according to claim 8 comprising means for continuous evaluation of the position of at least one part of the body of the user.

12. System according to claim 11, comprising means for giving an audio or/and visual signal to the user when a difference between the user's and the coach's postures is bigger than a predetermined one.

13. System according to claim 8, comprising means for updating the exercise programs according to the user's preferences.

14. Remote control for allowing access to an exercise or training program by a user at any time while watching TV or video, comprising:
an exercise button allowing the user to activate or select an exercise mode, e.g. by pressing or pushing this button, so that an exercise interface is shown or presented on at least part of a screen;
navigating or scrolling buttons allowing the user to review and navigate within a list of exercise programs pre-stored on a small memory or storing device, so that the user is able to choose a certain short-time exercise program from those on the list shown within the exercise interface; and
at least one button, e.g. a confirmation or OK button, allowing the user to confirm his/her choice(s) and to choose said certain short-time exercise program for playing or displaying it on at least part of the screen.

15. Computer readable and/or useable code on a computer readable and/or useable medium adapted to perform the method according to claim 1.
